(19) United States
(12) Patent Application Publication
(10) Pub. No.: US 2019/0058804 A1
(43) Pub. Date: Feb. 21, 2019

(54) SYSTEM AND METHOD FOR MULTIPLE DOCUMENT SCANNING

(71) Applicants: Kabushiki Kaisha Toshiba, Minato-ku (JP); Toshiba TEC Kabushiki Kaisha, Shinagawa-ku (JP)

(72) Inventors: Jia ZHANG, Irvine, CA (US); William SU, Riverside, CA (US); Christopher NGUYEN, Huntington Beach, CA (US)

(21) Appl. No.: 15/680,281

(22) Filed: Aug. 18, 2017

(51) Int. Cl. H04N 1/00; H04N 1/04

(52) U.S. Cl. CPC H04N 1/00811; H04N 1/0417; H04N 1/00588; H04N 1/00782; H04N 2201/0094; H04N 1/00474; H04N 1/00411; H04N 1/00037; H04N 1/0032

(57) ABSTRACT

A system and method for scanning two or more documents into a single scan file includes a multifunction peripheral having an intelligent controller including a processor and associated memory. A scanner of the multifunction peripheral includes first and second document feed modes. A user interface includes a display, such as a touchscreen display. A first sensor detects a presence of a first tangible document in the first feed mode. A second sensor detects a second document in the second feed mode. The controller enables the first feed mode to complete a first scan operation and generates a digital image file comprising images of the first document. The controller generates a prompt on the display for a selection of a continued scan operation. If selected, the second feed mode completes a second scan operation on the second document and generates the digital image file to include images of the second document.

### TECHNICAL FIELD

This application relates generally to multifunction peripherals with scanners configured to complete multiple scanning operations in a single session. The application related more particularly to multifunction peripherals that can accommodate a series of scans to a single electronic file with different scan properties selectable for each scan.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Scanners form an integral part of MFPs. Scanning hardware may be used to scan documents for copying, facsimile transmission or saving to an electronic file. Initially, each scan operation would result in a new electronic document or a separate facsimile. This could be problematic when one wishes multiple documents to be combined to a single file. Users might manually combine multiple files by manually combining them which could be problematic and time consuming. More recently, some MFPs may include a “Scan More” feature wherein a first scanned document and a second scanned document are combined in a single electronic file which can be saved to storage or sent to a destination, such as a fax machine or as an e-mail attachment. Current “Scan More” implementations have many limitations. For example, the scan setting cannot be changed between each scan. In another example, if a user would like to change DPI, he has to finish the current scan job, reset the setting, and restart another scan job. The user then has to merge the two documents together by himself if he would like to combine the two documents. Moreover, the current “Scan More” implementations further restrict that the scan source must be identical. If a user scans a document through the device exposure glass the first time, he could not subsequently scan the next document through the automatic document feeder, or ADF, when “Scan More” is desired. When a user scans through ADF the first time, there is no “Scan More” feature provided by MFP.

### SUMMARY

In accordance with an example embodiment of the subject application, a system and method for scanning of a series of documents into a single scan file includes a multifunction peripheral having an intelligent controller including a processor and associated memory. A scanner subsystem of the MFP includes first and second document feed modes. Human interaction is accomplished via a user interface including a display, such as a touchscreen display. A first sensor detects a presence of a first set of tangible documents in the first feed mode and a second sensor detects a second set of tangible documents in the second feed mode. The controller enables the first feed mode when a document is sensed in the first feed mode and first scan operation then generates a digital image file comprising images of the first set of tangible documents The controller then generates a prompt on the display for a selection of a continued scan operation. If it is selected, the controller enables the second feed mode to complete a second scan operation on a second set of tangible documents and generates the digital image file to include images of the second set of tangible documents.

### BRIEF DESCRIPTION OF THE DRAWINGS

Various embodiments will become better understood with regard to the following description, appended claims and accompanying drawings wherein:

FIG. 1 an example embodiment of a scanning system;

FIG. 2 is a further example embodiment of the scanning system of FIG. 1;

FIG. 3 is an example embodiment of a scanning system of FIG. 1 and FIG. 2;

FIG. 4 is a block diagram of an example embodiment of functional components of a multifunction peripheral;

FIG. 5 is a software module block diagram of an example embodiment of a scanning system; and

FIG. 6 is a flowchart of an example embodiment of a scanning system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Current “Scan More” functions on MFPs include many limitations. In one such limitation, scan settings must be fixed for all scans as they cannot be changed between each scan. For example, if user would like to change document resolution or pixel density of a scan, suitably measured in dots-per-inch, one would have to finish a current scan job, reset the corresponding scanner setting, and restart another scan job. This would result in two electronic files which, once again, a user would have to merge manually. Current “Scan More” functions also require restrict that the scan source be identical for each scan. If user scans initially by lifting a copier cover and placing a document on the device exposure glass the first time, they could not complete a subsequent scan by use of the device's automatic document feeder (“ADF”). When a user scans initially through the ADF the first time, no “Scan More” feature is provided by MFP.

As will be detailed below, the subject application details an MFP including functionality which facilitates a user ability to choose different scan setting before each scan of a “Scan More” operation. When a single output file type is to be used, that parameter is fixed for all scans. A user is able to change any suitable scan setting, such as color mode, scan resolution, paper size, rotation angel, and the like. The subject system suitably combines the documents in a single electronic file for the user automatically for each subsequent scan. The subject system enables automatic detection of documents at one or more alternative scan sources for each “Scan More” operation. By way of example, a scan source could be the device exposure glass or ADF without restriction between scans.

In an example embodiment, scanning may initially be done in a set file format for all documents, such as in a JPEG file type, but any other suitable default electronic file type may be used. The MFP allows for user chosen scan settings for each scan and suitably displays thumbnail images on the MFP display for each scanned document, suitably numbering each image in sequence. When all scans are complete, the subject system suitably programmatically combines the documents and converts the scan image file to a final file type set by user, after which file sequence numbering is suitably reset to zero afterward. Any suitable file type can be used as a final file format. Example file types include any suitable text, vector or image-based format, such as PDF, Tiff, Word, Excel, PowerPoint, and the like.

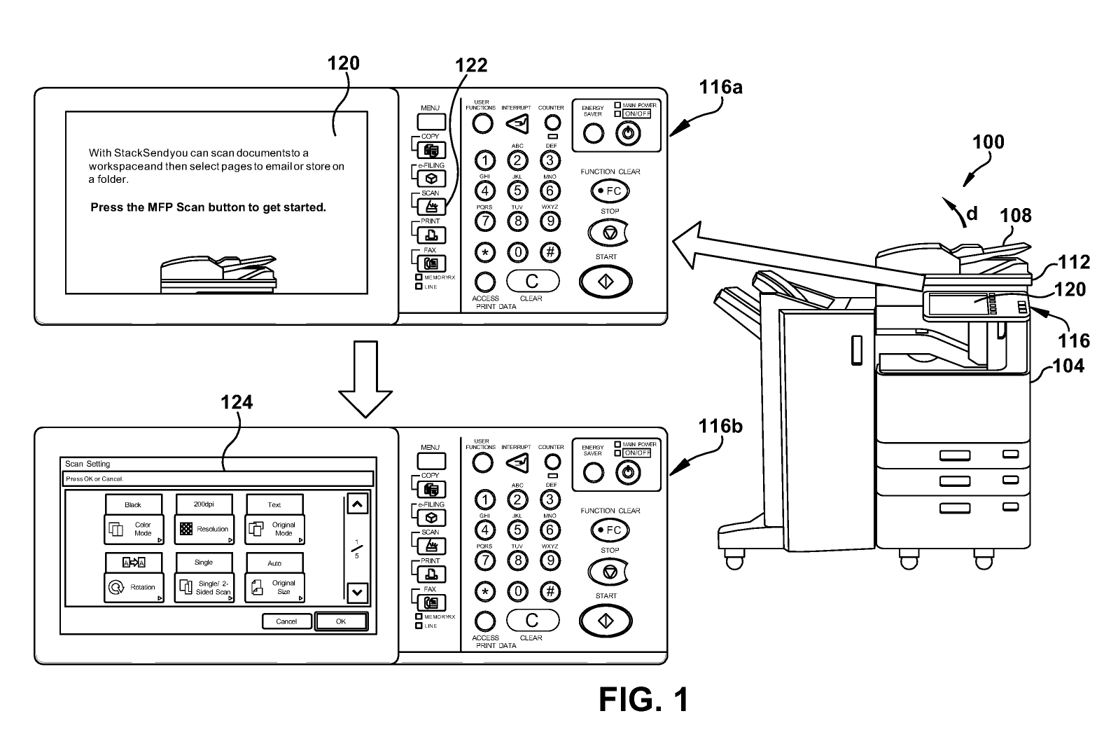

In accordance with the forgoing, FIG. 1 illustrates an example embodiment of a scanning system 100 operable on MFP 104. MFP 104 includes ADF 108 which is suitably raise-able in direction d to give access to exposure glass 112 for direct placement of documents for scanning. A user interface 116 includes a display 120, suitably a touchscreen display, and is operable in connection with a device controller as will be detailed below. When a user desires to complete a “Scan More” operation, a suitable rendering on the display 120 is provided on the user interface as illustrated at 116a. A user suitably commences a scan operation by pressing a scan select button 122. When a user selects a scan on user interface 116a, selection touchscreen display rendering 124 provides selectable scan options is suitably generated on the user interface as illustrated at 116b.

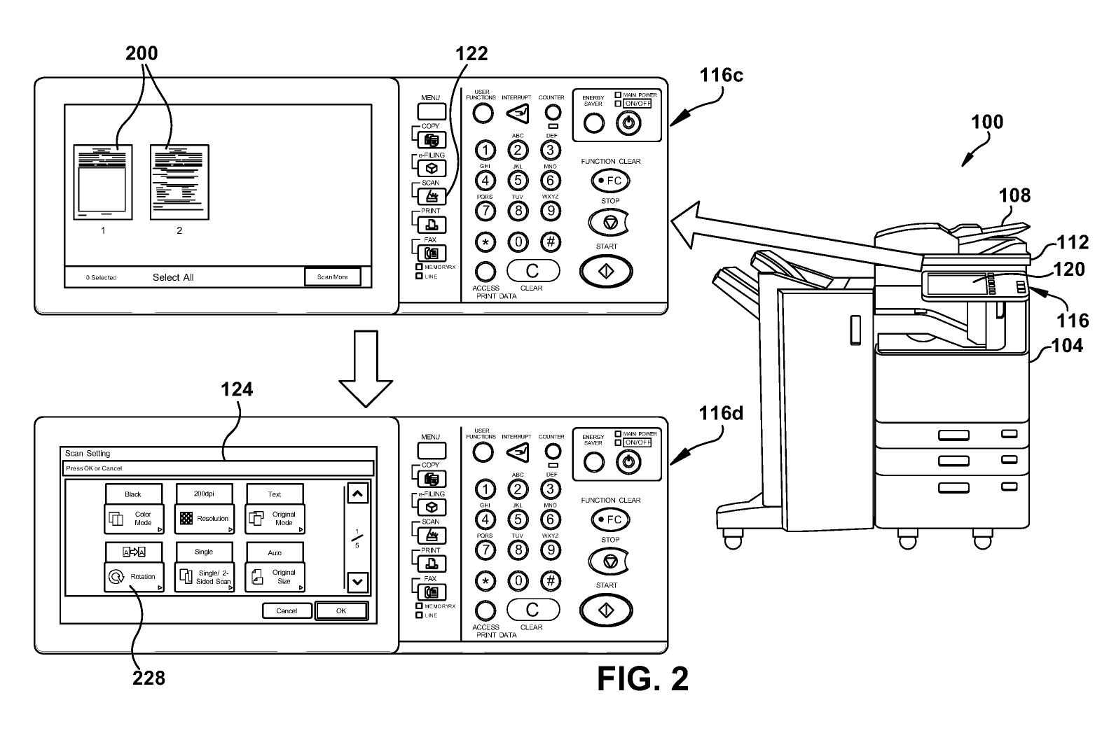

Referring now to FIG. 2, illustrated is the scanning system 100 wherein display 120 of user interface 116 generates a rendering of one or more scan image thumbnails 200 as illustrated at 116c. When another scan is to be made, a user selects another scan operation, such as by again depressing scan select button 122, or alternatively automatically by sensing documents in ADF 108 or a document present on exposure glass 112. After the second, or any subsequent, scan, settings may again be adjusted by display rendering 124 as illustrated at 116d. By way of example, selection of touchscreen button 128 suitably causes a rotation of a scanned document image in a fashion desired by the user.

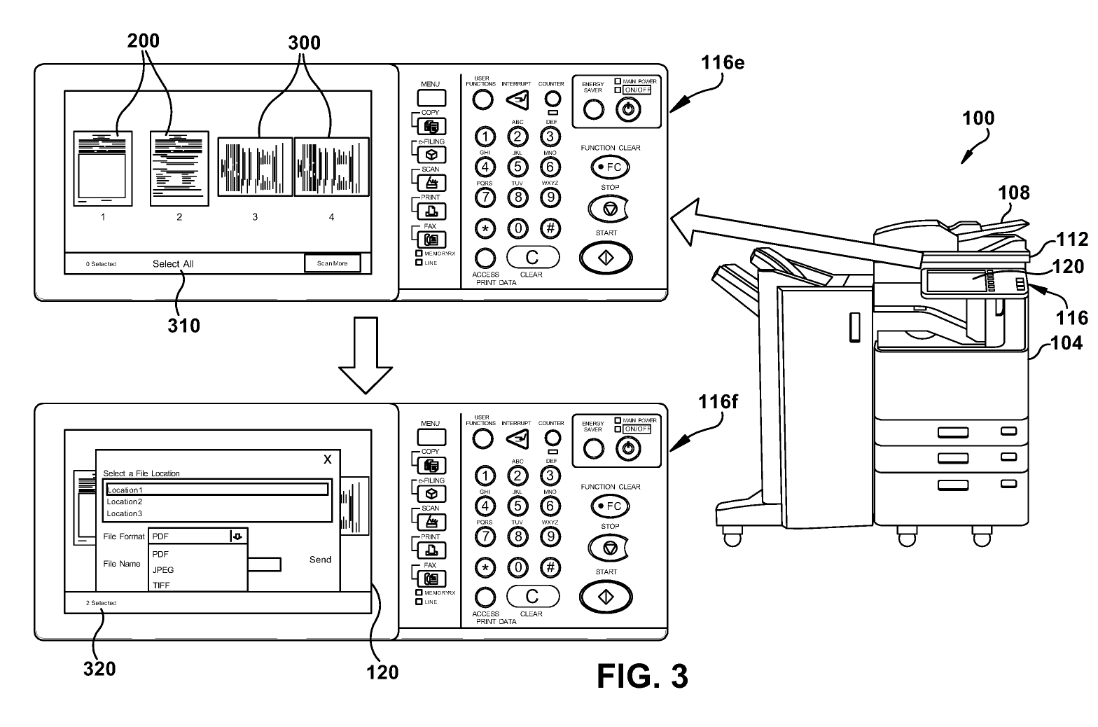

Referring next to FIG. 3, illustrated is the scanning system 100 wherein display 120 of the user interface as illustrated at 116e generates a rendering of thumbnail images 200 from FIG. 2, supplemented by thumbnail images 300 from the second scan discussed above. Any further scanning operations would also generate revised sets of thumbnail images in a similar fashion, with scrolling suitably provided if too many images exist relative to a display size to display concurrently. Note in the illustrated example embodiment that thumbnail images 200 are oriented differently that thumbnail images 300. This may be attributed to paper orientation during a scan, or by user-selected rotation by selection of button 228 as noted above. In the illustrated example, a user next depresses the “Select All” button 310 from the touchscreen display 120 of user interface 116e, leading to rendering 320 prompting the user for a location and file type for the resultant combined scan file as illustrated at 116f.

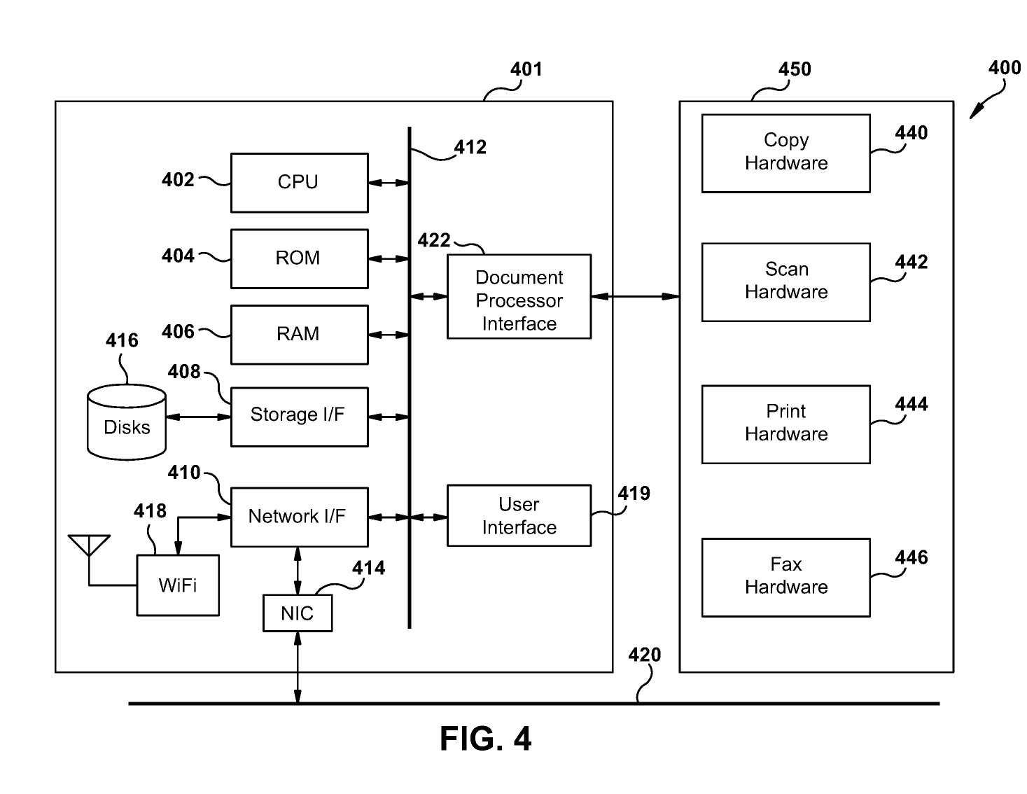

Turning now to FIG. 4, illustrated is an example embodiment of functional device components 400 suitably comprising a multifunctional peripheral such as MFP 104 of FIG. 1. Included is controller 401 comprised of one or more processors, such as that illustrated by processor 402. Each processor is suitably associated with non-volatile memory such as ROM 404, and random access memory (RAM) 406, via a data bus 412.

Processor 402 is also in data communication with a storage interface 408 for reading or writing to a storage 416, suitably comprised of a hard disk, optical disk, solid-state disk, cloud-based storage, or any other suitable data storage as will be appreciated by one of ordinary skill in the art.

Processor 402 is also in data communication with a network interface 410 which provides an interface to a network interface controller (NIC) 414, which in turn provides a data path to any suitable wired or physical network connection 420, or to a wireless data connection via wireless network interface 418. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like.

Processor 402 can also be in data communication with any suitable user input/output (I/O) interface 419 which provides data communication with user peripherals, such as displays, keyboards, mice, track balls, touch screens, or the like.

Also in data communication with data bus 412 is a document processor interface 422 suitable for data communication with MFP functional units 450. In the illustrated example, these units include copy hardware 440, scan hardware 442, print hardware 444 and fax hardware 446 which together comprise MFP functional hardware 450. It will be understood that functional units are suitably comprised of intelligent units, including any suitable hardware or software platform.

Hardware monitors suitably provide device event data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, such as in storage 416.

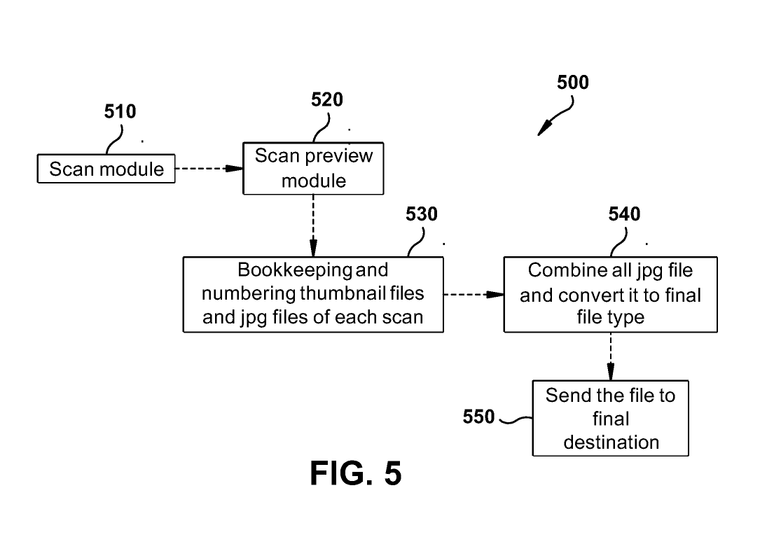

Turning to FIG. 5, illustrated is an example embodiment of a software module block diagram 500 suitable for accomplishing the forgoing in concert with an MFP embedded controller, such as MFP 104 of FIG. 1 having controller 401 of FIG. 4. In the example, a scan module 510 commences a scanning operation. Thumbnails are generated and displayed by scan preview module 520. Next, image accounting module 530 provides bookkeeping, such as numbering of thumbnail files, each of which are suitably in the same, default scan file format such as JPEG as illustrated in the example. Next, image processing module 540 functions to combine all individual JPEG files into a single output file in a file format desired by a user. Next, the complete image file is sent to a desired destination, such as a memory, disk, flash drive, e-mail address, network location or wireless or tethered data device, via output module 550.

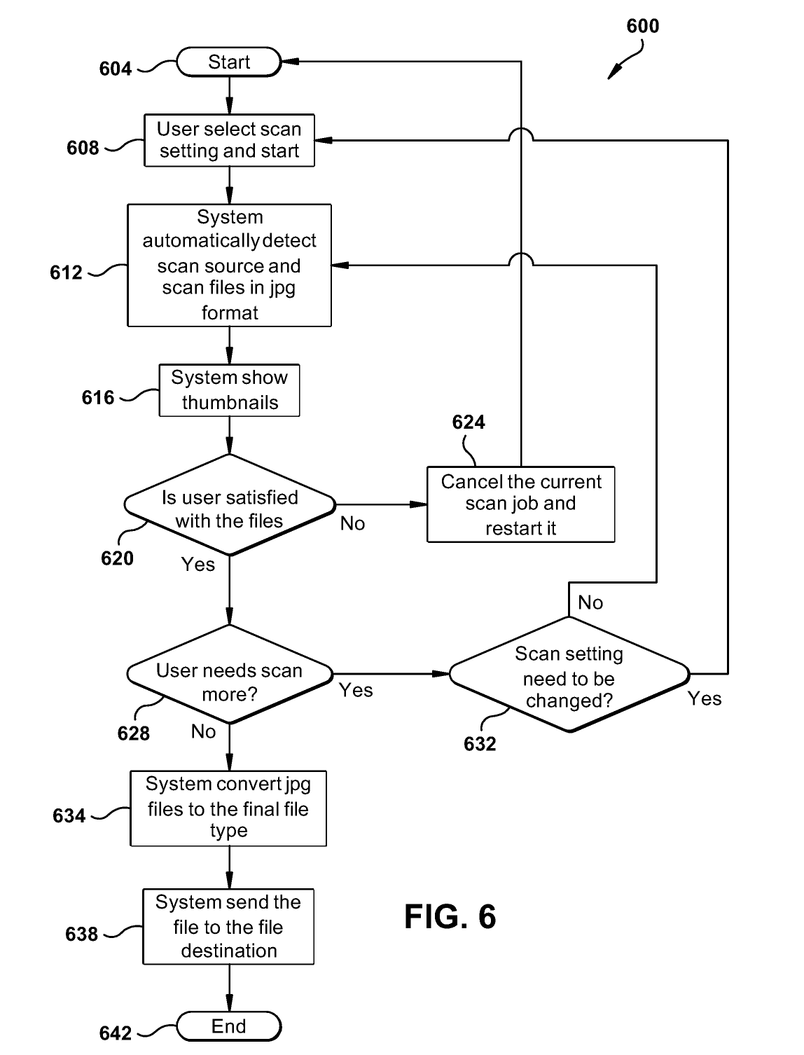

Referring next to FIG. 6, illustrated is a flowchart 600 of an example embodiment of a “Scan More” operation such as that described above. The process commences at block 604 and proceeds to block 608 when a user selects a scan operation. Next, at block 612 the system automatically detects a scan source, such as with a paper detector on an ADF or an exposure glass, and commences a scan in a default file format, such as JPEG. Next, thumbnails of the scanned pages are displayed at block 616. If the user indicates dissatisfaction with the thumbnail images at block 620, that particular scan is aborted at block 624, the system returns to block 604 and the process recommences. If the user is satisfied, progress is made to block 628 wherein the user is prompted to decide whether additional scans are to follow. If so, if the user selects to change scan settings at block 632, the process returns to block 608 and new settings are input. If no changes in settings are required, the process returns to block 612 and the next scan is started, automatically if input is detected. If no more scans are selected at block 628, the individual JPEG files are converted to a single file and converted to a desired file format, if the native JPEG file format is not selected, at block 634. Finally, the combined/converted file is sent to a desired destination at block 638 and the process ends at block 642.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A multifunction peripheral comprising:
an intelligent controller including a processor and associated memory;
a scanner having first and second document feed modes configured to generate digitized images of tangible documents;
a user interface including a display and a user input;
a first sensor configured to generate a first indicator output corresponding to a presence of a first set of tangible documents in the first feed mode; and
a second sensor configured to generate a second indicator output corresponding to a presence of a second set of tangible documents in the second feed mode;
wherein the controller is configured to enable the first feed mode in accordance with the first indicator to complete a first scan operation to generate a first digital image file comprising an image of the first set of tangible documents,
wherein the controller is further configured to generate a first thumbnail image of the first digital image file on the display,
wherein the user input is configured for receiving first user edit selection input corresponding to an edit to the first digital image file associated with the first thumbnail image,
wherein the controller is further configured to generate a second digital image file in accordance with received first edit selection input,
wherein the controller is further configured to generate a second thumbnail image from the second digital image file on the display,
wherein the controller is further configured to generate a prompt on the display corresponding to a selection for a continued scan operation,
wherein the user input is configured for receiving user selection input corresponding to a selection for the continued scan operation,
wherein the controller is further configured to enable the second feed mode to complete a second scan operation on a second set of tangible documents in accordance with the second indicator and the user selection input
wherein the controller is further configured to generate a third digital image file comprising an image of the second set of tangible documents,
wherein the controller is further configured to generate a third thumbnail image from the third digital image file on the display,
wherein the user input is configured for receiving user a second edit selection input corresponding to an edit to the third digital image file associated with the third thumbnail image,
wherein the controller is further configured to selectively generate a fourth digital image file in accordance with received second edit selection input,
wherein the controller is further configured to generate the second thumbnail image and the fourth thumbnail image concurrently on the display, and
wherein the controller is further configured to generate a combined image file including image data from the second digital image file and image data from the fourth image file.

2. The multifunction peripheral of claim 1 wherein the controller is further configured to complete the first scan operation at a first scan setting, and
wherein the controller is further configured to complete the second scan operation at a second scan setting different from the first scan setting.

3. The multifunction peripheral of claim 2 wherein the controller is further configured to receive a selection specifying at least one scan setting via the user input.

4. The multifunction peripheral of claim 3 wherein the at least one scan setting includes one or more of a setting associated with color mode, image resolution, paper size or page rotation angle.

5. The multifunction peripheral of claim 4 wherein the controller is further configured to generate the combined digital image file in a format specified by a user via the user input.

6. The multifunction peripheral of claim 1 further comprising an automatic document feeder corresponding to the first scan mode.

7. The multifunction peripheral of claim 1 further comprising an automatic document feeder corresponding to the second scan mode.

8. A method comprising:
sensing a presence of a first tangible document in connection with a first feed mode of a scanner;
commencing, via an intelligent controller of a multifunction peripheral, a scan of the first tangible document responsive to a sensed presence of the first tangible document;
generating a first digital image file comprising an image of the first tangible document;
generating a first thumbnail image of the first digital image file on the display,
receiving first user edit selection input corresponding to an edit to the first digital image file associated with the first thumbnail image,
generating a second digital image file in accordance with received first edit selection input,
generating a second thumbnail image from the second digital image file on the display,
sensing a presence of a second tangible document in connection with a second feed mode of the scanner;
generating a prompt on a display for user selection of a continued scan operation;
receiving user selection data responsive to the generated prompt;
commencing, via the intelligent controller, a scan of a second tangible document in connection with a second feed mode of the scanner responsive to the sensed presence of the second tangible document and the user selection data;
generating a third digital image file comprising an image of the second set of tangible documents;
generating a third thumbnail image from the third digital image file on the display,
receiving user a second edit selection input corresponding to an edit to the third digital image file associated with the third thumbnail image,
generating a fourth digital image file in accordance with received second edit selection input,
generating the second thumbnail image and the fourth thumbnail image concurrently on the display, and
generating a combined image file including image data from the second digital image file and image data from the fourth image file.

9. The method of claim 8 further comprising:
completing the first scan operation at a first scan setting, and
completing the second scan operation at a second scan setting different from the first scan setting.

10. The method of claim 9 further comprising receiving a selection specifying at least one scan setting via a user input.

11. The method of claim 10 further comprising receiving the at least one scan setting including one or more of a setting associated with color mode, image resolution, paper size or page rotation angle.

12. The method of claim 11 further comprising generating the combined digital file in a format specified by a user via the user input.

13. The method of claim 8 further comprising enabling an automatic document feeder in connection with the scan of the first tangible document.

14. The method of claim 8 further comprising enabling an automatic document feeder in connection with the scan of the second tangible document.

15. A multifunction peripheral comprising:
a scanner;
an automated document feeder including a paper sensor;
a touchscreen display
an intelligent controller including a processor and associated memory,
the controller configured to enable the scanner and automated document feeder to commence a first scan operation of a first tangible document determined by the paper sensor to be present in the document feeder,
the controller further configured to determine, via the paper sensor, a presence of a second tangible document in the document feeder, and
the controller further configured to generate, after completion of the first scan operation, a continued scan user prompt on an associated display for selection of a continued scan operation including the second tangible document when the second tangible document is sensed by the paper sensor; and
a user input configured to receive a continued scan user selection corresponding to the user prompt,
wherein the controller is further configured to selectively enable the scanner and automated document feeder to commence a second scan operation of the second tangible document responsive to a received user selection,
wherein the controller is further configured to generate a first digital image file comprising a digital image of the first tangible document and a second digital image file comprising a digital image of the second tangible document,
wherein the controller is further configured to generate a thumbnail image of the first digital image file and a thumbnail image of the second digital image file on the display,
wherein the controller is further configured to modify the first image data file in accordance with instruction a received from a user,
wherein the controller is further configured to modify the second image data file in accordance with instructions received from the user, and
wherein the controller is further configured to generate an combined digital image file in accordance with data from the first image data file and the second image file when at least one image file has been modified.

16. The multifunction peripheral of claim 15
wherein the controller is further configured to generate, on the display, a scan setting user prompt for selection of at least one scan setting,
wherein the user input is configured to receive a user scan setting selection corresponding to the scan setting user prompt, and
wherein the controller is further configured for completing one or more of the first scan operation or the second scan operation in accordance with a received user scan setting selection.

17. The multifunction peripheral of claim 16 wherein the scan setting comprises one or more of color mode, image resolution, paper size or page rotation angle.

18. The multifunction peripheral of claim 15
wherein the controller is further configured to generate, on the display, a file format user prompt for selection of at least one output file format,
wherein the user input is further configured to receive a user file format selection corresponding to the file format user prompt, and
wherein the controller is further configured for generating the combined digital image file in a file format corresponding to a received file format selection.

19. The multifunction peripheral of claim 15 wherein the controller is further configured to save the combined digital image file to an associated memory.

20. The multifunction peripheral of claim 15 wherein the controller is further configured to transmit the digital file to a user-selected destination.
